(19) United States
(12) Patent Application Publication
(10) Pub. No.: US 2009/0027395 A1
(43) Pub. Date: Jan. 29, 2009

(54) Machine-implemented method and electronic device for presenting a normalized graph for a plurality of data sets

(75) Inventors: Chang-Shan Chuang, Taipei City (TW); Hao-Yuan Chuang, Taipei City (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Chii Ying Co., Ltd., Taipei City (TW)

(21) Appl. No.: 12/220,639

(22) Filed: Jul. 24, 2008

(30) Foreign Application Priority Data
Jul. 26, 2007 (TW) 096127365
May 28, 2008 (TW) 097119669

(51) Int. Cl. G06T 11/20

(52) U.S. Cl. 345/440

(57) ABSTRACT

A machine-implemented method is disclosed for presenting a normalized graph for a plurality of data sets, each data set having a plurality of data points each including a numerical first coordinate and a second coordinate. The machine-implemented method includes: reading the data sets; for each data set, multiplying the first coordinate of each data point by a scalar to result in normalized first coordinates for the data points; setting first and second boundaries of a first coordinate axis of the normalized graph based on the normalized first coordinates of all data points of the data sets; and plotting all data points of all data sets on a same coordinate plane defined by the first and second boundaries of the first coordinate axis and a second coordinate axis using the normalized first coordinates instead of the numerical first coordinates. An electronic device for presenting a normalized graph is also disclosed.

### CROSS-REFERENCE TO RELATED APPLICATION

This application claims priority of Taiwanese Application Nos. 096127365 and 097119669, filed on Jul. 26, 2007 and May 28, 2008, respectively.

### BACKGROUND OF THE INVENTION

1. Field of the Invention

The present invention relates to a machine-implemented method and an electronic device for presenting a normalized graph for a plurality of data sets, in which data points of the data sets are normalized to result in a clearer, more meaningful presentation of the data sets on the normalized graph.

2. Description of the Related Art

It is often desirable to present a plurality of data sets on a single graph. Microsoft Office EXCEL® may be used for such a purpose. The graph of FIG. 1 is presented using Microsoft Office EXCEL®, and shows inflation rates, economic growth rates, and average unemployment rates in the United States from 1984 to 2004, and worldwide average gold prices and inflation-adjusted oil prices over this same period.

However, due to the different units of measurement among the data sets (i.e., percentage versus US dollars), and the differences in scale among the data sets (e.g., average gold prices between 300 and 400 dollars versus economic grow rates within a narrow range of low percentage values), only variations in the average gold prices are clearly discernible in the graph. With respect to the other data sets, no meaningful information may be obtained from the graph.

### SUMMARY OF THE INVENTION

Therefore, an object of the present invention is to provide a machine-implemented method and an electronic device for presenting a normalized graph for a plurality of data sets, in which data points of the data sets are normalized to result in a clearer, more meaningful presentation of the data sets on the normalized graph.

According to one aspect, the machine-implemented method of this invention for presenting a normalized graph for a plurality of data sets, in which each of the data sets has a plurality of data points and each of the data points includes a numerical first coordinate and a second coordinate, includes: a) reading the plurality of data sets; b) for each of the data sets, multiplying the first coordinate of each of the data points of the data set by a scalar to result in normalized first coordinates for the data points of the data set, the scalar being based upon the first coordinate of one of the data points having a maximum absolute value among the first coordinates of all of the data points of the data set; c) setting first and second boundaries of a first coordinate axis of the normalized graph based on at least one of a minimum value and a maximum value among the normalized first coordinates of all of the data points of the data sets; and d) plotting all of the data points of all of the data sets on a same coordinate plane defined by the first and second boundaries of the first coordinate axis and a second coordinate axis using the normalized first coordinates instead of the numerical first coordinates of the data points of the data sets.

According to another aspect, the electronic device of this invention capable of presenting a normalized graph for a plurality of data sets, in which each of the data sets has a plurality of data points and each of the data points includes a numerical first coordinate and a second coordinate, includes: a user interface for allowing user input of an input instruction associated with the data sets; a reader coupled to the user interface to receive the input instruction, and reading the data sets in accordance with the input instruction; a normalization module coupled to the reader, and which, for each of the data sets, multiplies the first coordinate of each of the data points of the data set by a scalar to result in normalized first coordinates for the data points of the data set, the scalar being based upon the first coordinate of one of the data points having a maximum absolute value among the first coordinates of all of the data points of the data set; a boundary-setting module coupled to the normalization module, and setting first and second boundaries of a first coordinate axis of the normalized graph based on at least one of user input, a minimum value among the normalized first coordinates of all of the data points of the data sets, and a maximum value among the normalized first coordinates of all of the data points of the data sets; and a graph-presenting module coupled to the boundary-setting module, the normalization module, and the reader, and plotting all of the data points of all of the data sets on a same coordinate plane defined by the first and second boundaries of the first coordinate axis and a second coordinate axis using the normalized first coordinates instead of the numerical first coordinates of the data points of the data sets.

### BRIEF DESCRIPTION OF THE DRAWINGS

Other features and advantages of the present invention will become apparent in the following detailed description of the preferred embodiment with reference to the accompanying drawings, of which:

FIG. 1 is a graph of a plurality of data sets presented using Microsoft Office EXCEL®;

FIG. 2 is a block diagram of an electronic device that is capable of presenting a normalized graph for af plurality of data sets according to a preferred embodiment of the present invention;

FIG. 3 is a flowchart of a machine-implemented method for presenting a normalized graph for a plurality of data sets according to a preferred embodiment of the present invention;

FIG. 4 is a graph of a plurality of data sets presented using the preferred embodiment;

FIG. 5 is a graph similar to FIG. 4 and which is presented using the preferred embodiment, but illustrating a different setting of first and second boundaries of a first coordinate axis;

FIG. 6 is a graph of a plurality of data sets different from the data sets used to present the graphs of FIGS. 1, 4, and 5, and presented using Microsoft Office EXCEL®;

FIG. 7 is a graph similar to FIG. 6, but which is presented using the preferred embodiment;

FIG. 8 shows two tables of data points of data sets prior and subsequent to undergoing normalization according to the preferred embodiment; and

FIG. 9 shows two tables of data points of different data sets, which are different from the data sets of FIG. 8, prior and subsequent to undergoing normalization according to the preferred embodiment.

### DETAILED DESCRIPTION OF THE PREFERRED EMBODIMENT

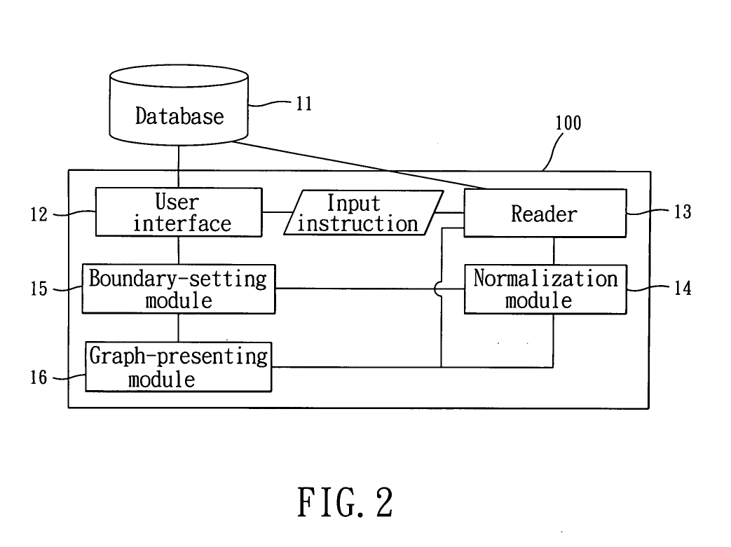

Referring to FIG. 2, the preferred embodiment of an electronic device 100 capable of presenting a normalized graph for a plurality of data sets according a to the present invention includes a user interface 12, a reader 13, a normalization module 14, a boundary-setting module 15, and a graph-presenting module 16. Each of data sets has a plurality of data points, and each of the data points includes a numerical first coordinate and a second coordinate. The electronic device 100 is exemplified as a computer in this embodiment, but may be a personal digital assistant, a smart phone, etc., in other embodiments of this invention.

The user interface 12 allows user input of an input instruction that is associated with the data sets. The reader 13 is coupled to the user interface 12 to receive the input instruction, and reads the data sets in accordance with the input instruction. In one embodiment, the reader 13 is coupled to a database 11 that stores the data sets, and the input instruction received from the user interface 12 causes the reader 13 to read the data sets in the database 11. In another embodiment, the database 11 is a part of the electronic device 100, and in such an embodiment, the user inputs the data sets into the database 11 through the user interface 12 any time prior to input of the input instruction. In yet another embodiment, the user inputs the data sets through the user interface 12 as part of the input instruction, and the reader 13 reads the data sets contained in the input instruction after receiving the same.

The normalization module 14 is coupled to the reader 13. For each of the data sets, the normalization module 14 multiplies the first coordinate of each of the data points of the data set by a scalar to result in normalized first coordinates for the data points of the data set. The scalar is based upon the first coordinate of one of the data points having a maximum absolute value among the first coordinates of all of the data points of the data set.

In one embodiment, for each of the data sets, the scalar is a reciprocal of an absolute value of the first coordinate of the one of the data points having the maximum absolute value among the first coordinates of all of the data points of the data set. In some embodiments, for each of the data sets, the normalization module 14 calculates the scalar of the data set by determining the absolute values of the first coordinates of all of the data points of the data set, selecting a maximum one of the determined absolute values, and obtaining a reciprocal of the maximum one of the determined absolute values to serve as the scalar of the data set. In other embodiments, for each of the data sets, the normalization module 14 calculates the scalar of the data set by arranging the first coordinates of all of the data points of the data set in a sequence according to one of an ascending order and a descending order, selecting first and last ones of the first coordinates in the sequence, determining absolute values of the first and last ones of the first coordinates in the sequence, and obtaining a reciprocal of a larger one of the absolute values of the first and last ones of the first coordinates in the sequence to serve as the scalar of the data set.

In some embodiments, the normalization module 14 divides the first coordinate of each of the data points of the data set by a scalar to result in normalized first coordinates for the data points of the data set. In such embodiments where division using the scalar is employed by the normalization module 14, the scalar is an absolute value of (and not a reciprocal of an absolute value of) the first coordinate of the one of the data points having the maximum absolute value among the first coordinates of all of the data points of the data set.

The boundary-setting module 15 is coupled to the normalization module 14. In the preferred embodiment, the boundary-setting module 15 sets first and second boundaries of a first coordinate axis of the normalized graph based on at least one of a minimum value and a maximum value among the normalized first coordinates of all of the data points of the data sets.

In one embodiment, the boundary-setting module 15 sets the first boundary to be +1, and the second boundary to be equal to the minimum value among the normalized first coordinates of all of the data points of all of the data sets.

In another embodiment, the boundary-setting module 15 sets the first boundary to be equal to the maximum value among the normalized first coordinates of all of the data points of all of the data sets, and the second boundary to be −1.

In yet another embodiment, the boundary-setting module 15 sets the first and second boundaries to be +1 and −1, respectively.

In still another embodiment, the boundary-setting module 15 sets the first boundary to be equal to the maximum value among the normalized first coordinates of all of the data points of all of the data sets, and the second boundary to be equal to the minimum value among the normalized first coordinates of all of the data points of all of the data sets.

In a further embodiment, the boundary-setting module 15 is coupled to the user interface 12, and the boundary-setting module 15 sets the first and second boundaries of the first coordinate axis of the normalized graph based on user input of a boundary instruction through the user interface 12.

The graph-presenting module 16 is coupled to the boundary-setting module 15, the normalization module 14, and the reader 13. The graph-presenting module 16 plots all of the data points of all of the data sets on a same coordinate plane defined by the first and second boundaries of the first coordinate axis and a second coordinate axis using the normalized first coordinates instead of the numerical first coordinates of the data points of the data sets. The graph-presenting module 16 is exemplified as a computer display in this embodiment but may be a computer printer in other embodiments of this invention.

Specific examples of presenting a normalized graph using the electronic device 100 of the present invention will now be provided.

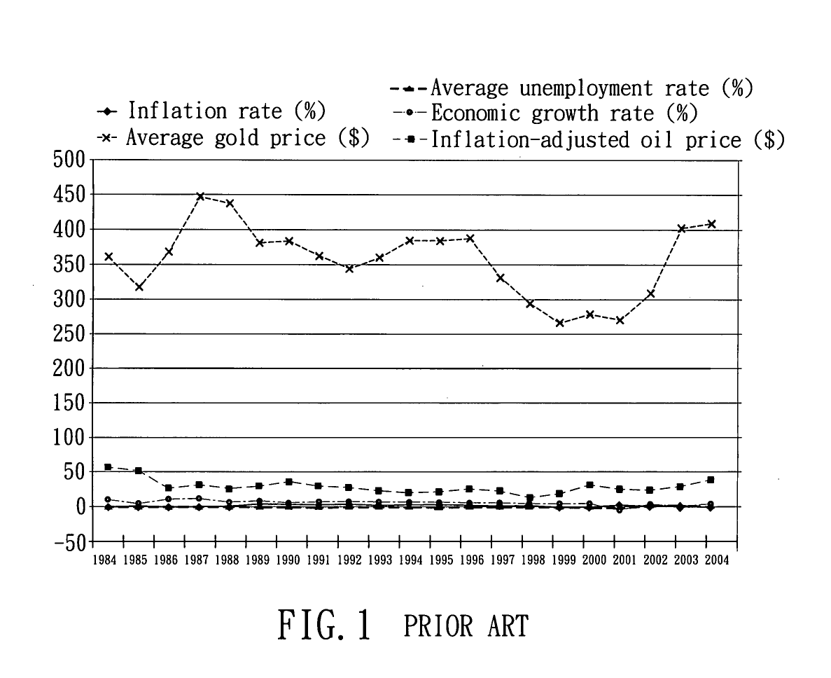

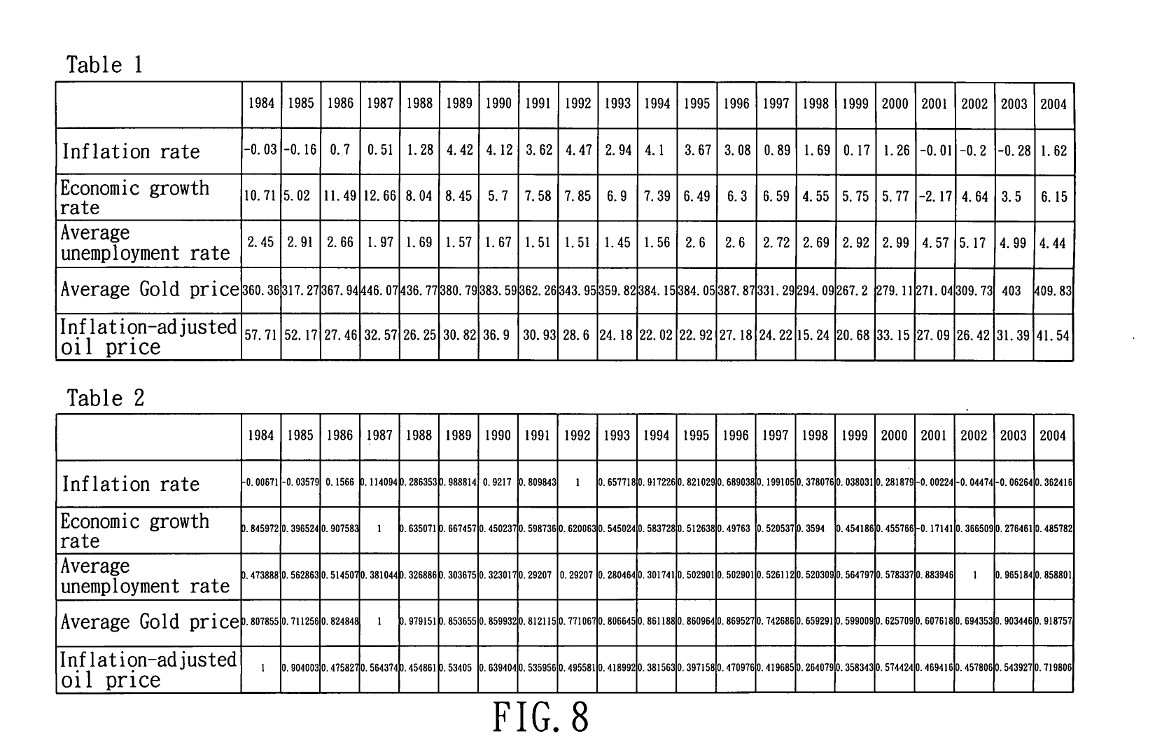

Referring to FIG. 8, Table 1 presented therein lists a plurality of data sets. In particular, the data sets of Table 1 are related to inflation rates, economic growth rates, average unemployment rates, average gold prices, and inflation-adjusted oil prices from 1984 to 2004 in the United States. When Microsoft Office EXCEL® is used to present a graph of these data sets, the graph of FIG. 1 results. The problems associated with such a graph have been discussed fully herein above.

In contrast, through use of the present invention, for each of the data sets, the first coordinate (i.e., the y-coordinate in this example) of each of the data points of the data set are multiplied by a scalar to result in normalized first coordinates for the data points of the data set. Table 2 of FIG. 8 shows the results of such an operation by the normalization module 14. In this example, the scalar used by the normalization module 14 is a reciprocal of an absolute value of the first coordinate of one of the data points having a maximum absolute value among the first coordinates of all of the data points of the data set.

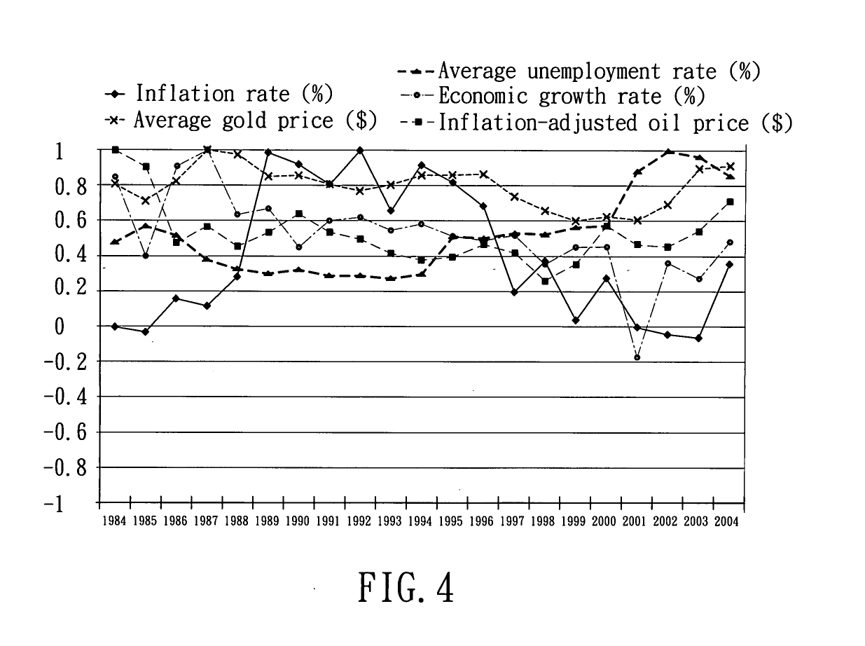

Assuming that the boundary-setting module 15 sets the first and second boundaries to be +1 and −1, respectively, the data sets appearing in Table 2 may be presented as a normalized graph by the graph-presenting module 16 as shown in FIG. 4. In the graph of FIG. 4, the fluctuations in each curve for each of the data sets are clearly visible. This makes comparison and analysis among the data sets easy. For example, it may be possible to determine whether any correlation exists between or among two or more of the data sets.

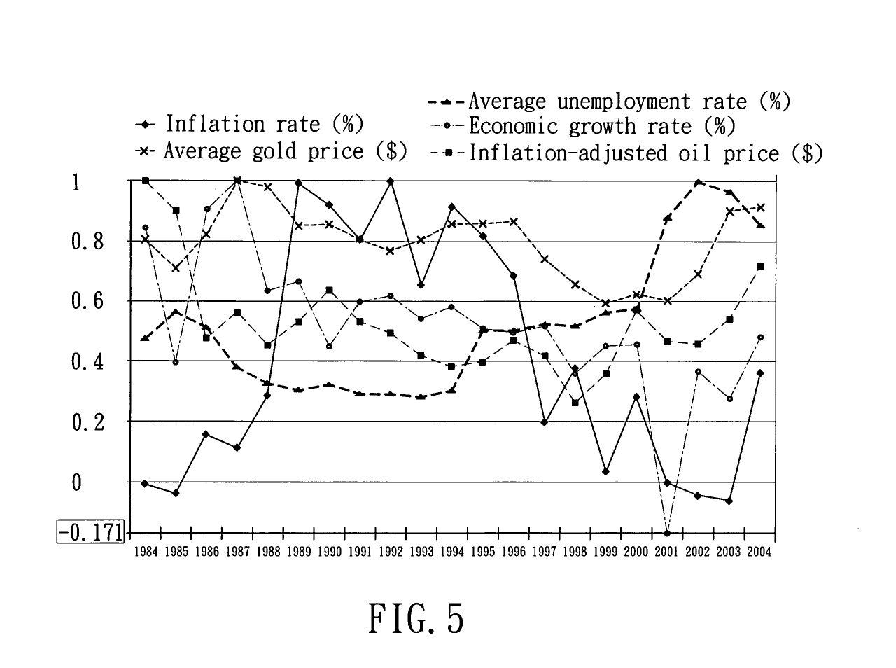

To improve on the graph presented in FIG. 4, the boundary-setting module 15 may set the first and second boundaries differently to result in the graph of FIG. 5. In the graph of FIG. 5, the boundary-setting module 15 has set the first boundary to be +1, and the second boundary to be equal to the minimum value among the normalized first coordinates of all of the data points of all of the data sets (i.e., −0.171 in this example). Hence, the fluctuations in each curve for each of the data sets are even more clearly presented.

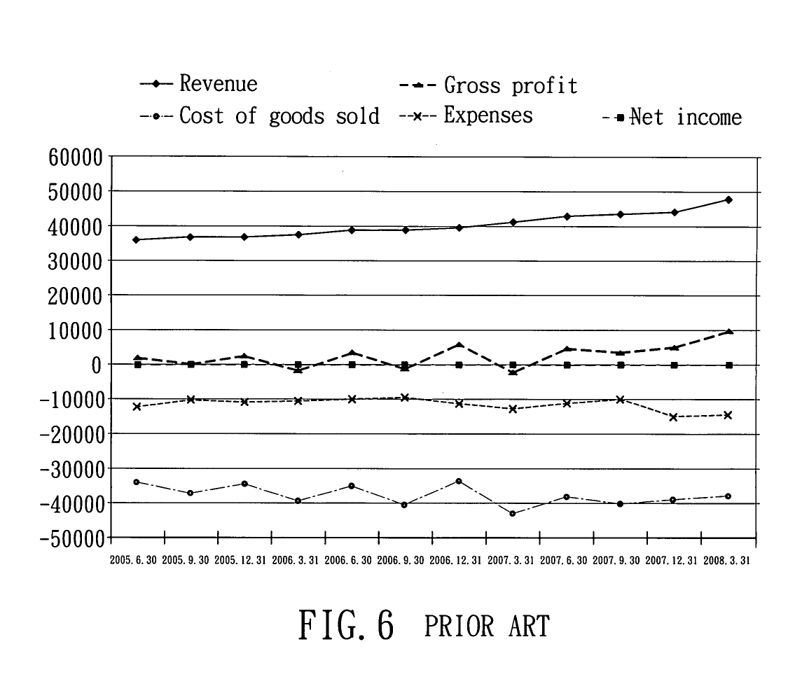

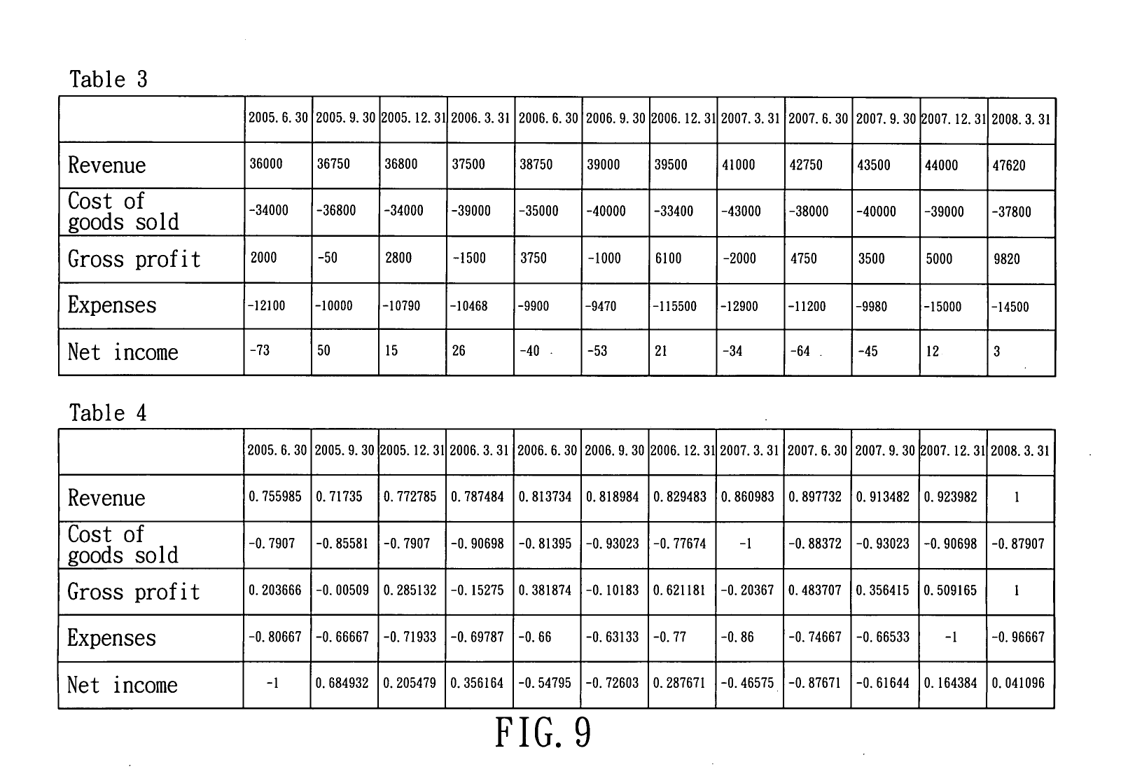

Another example of using the electronic device 100 to present a normalized graph will be described with reference to FIGS. 6, 7, and 9. Table 3 in FIG. 9 presents data sets for a hypothetical company related to revenue, cost of goods sold, gross profit, expenses, and net income for each quarter and over a particular time period.

When Microsoft Office EXCEL® is used to present a graph of the data sets of Table 3, the graph of FIG. 6 results. As shown in FIG. 6, no real fluctuations in the curves for the data sets are visible.

Through use of the present invention, for each of the data sets, the first coordinate (i.e., the y-coordinate in this example) of each of the data points of the data set are multiplied by a scalar to result in normalized first coordinates for the data points of the data set. Table 4 of FIG. 9 shows the results of such an operation by the normalization module 14. In this example, the scalar used by the normalization module 14 is a reciprocal of an absolute value of the first coordinate of one of the data points having a maximum absolute value among the first coordinates of all of the data points of the data set.

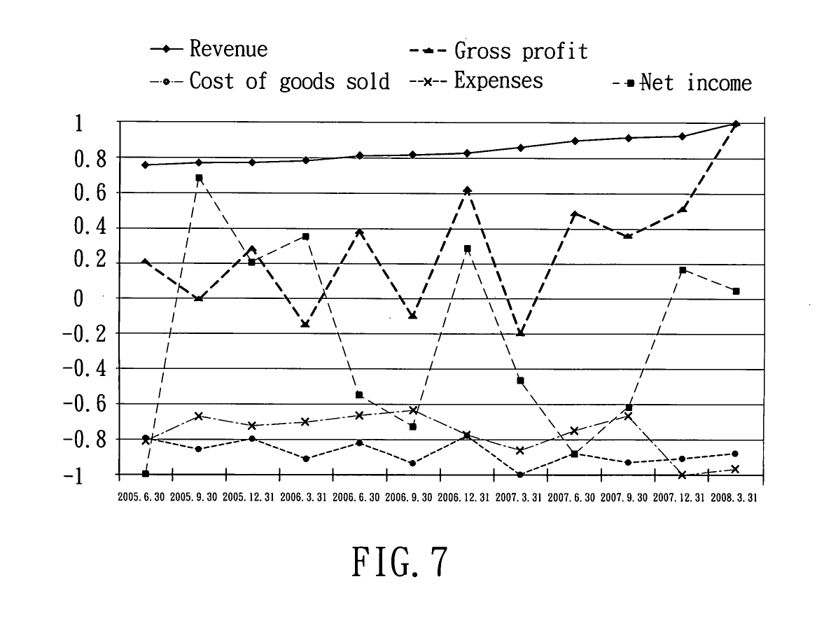

Assuming that the boundary-setting module 15 sets the first and second boundaries to be +1 and −1, respectively, the data sets appearing in Table 4 may be presented as a normalized graph by the graph-presenting module 16 as shown in FIG. 7. In the graph of FIG. 7, the fluctuations in each curve for each of the data sets are clearly visible.

In the examples provided above, the data points of each of the data sets are plotted in a line graph. However, the present invention is not limited in this regard, and the data points of each of the data sets may be plotted in a bar chart. In such an embodiment where the normalized graph presented by the electronic device 100 of the present invention is a bar chart, the first and second boundaries maybe adjusted by a predetermined amount so that when any normalized first coordinates have small values, they are clearly visible in the resulting normalized bar chart.

Furthermore, in the examples provided above, the first and second coordinates of each of the data points are an ordinate and an abscissa, respectively, of a Cartesian coordinate system. However, the present invention is not limited in this regard. That is, although the first coordinates, which are scaled by the scalar, are y-coordinates (or ordinates) in the examples above, the present invention is not limited in this respect and in some embodiments, the first coordinates may be x-coordinates. For example, the normalized graph may be presented as a horizontal bar chart, in which case the x-coordinates are the first coordinates and therefore undergo normalization.

Additionally, in the examples provided above, the second coordinate of each of the data points is a time coordinate, e.g., years in Tables 1 and 2 and FIGS. 4 and 5. However, the present invention is not limited in this respect and the second coordinate, which does not undergo normalization by the normalization module 15, may be any type of ordinal coordinate (i.e., a coordinate provided in some form of order or succession), or may be names of countries, companies, etc., such as when the normalized graph is a bar chart.

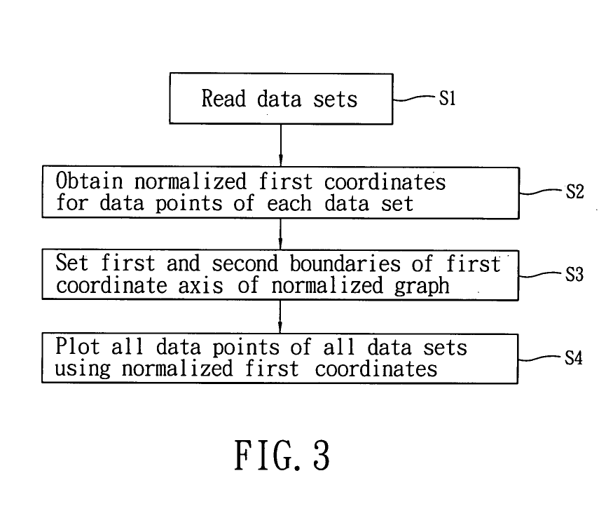

A machine-implemented method for presenting a normalized graph for a plurality of data sets will now be described with reference to FIG. 3. As in the case of the electronic device 100 of the present invention, each of the data sets has a plurality of data points, and each of the data points includes a numerical first coordinate and a second coordinate.

First, in step S1, the plurality of data sets are read.

Next, in step S2, for each of the data sets, the first coordinate of each of the data points of the data set is multiplied by a scalar to result in normalized first coordinates for the data points of the data set. The scalar is based upon the first coordinate of one of the data points having a maximum absolute value among the first coordinates of all of the data points of the data set.

In step S3, first and second boundaries of a first coordinate axis of the normalized graph are set based on at least one of a minimum value and a maximum value among the normalized first coordinates of all of the data points of the data sets.

Finally, in step S4, all of the data points of all of the data sets are plotted on a same coordinate plane defined by the first and second boundaries of the first coordinate axis and a second coordinate axis using the normalized first coordinates instead of the numerical first coordinates of the data points of the data sets.

The different embodiments encompassed by the machine-implemented method of the present invention, and any additional steps and further conditions thereof should be evident from the description of the electronic device 100 of the present invention presented above. Furthermore, the advantages of the machine-implemented method of the present invention are the same as those realized by the electronic device 100 of the present invention.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A machine-implemented method for presenting a normalized graph for a plurality of data sets, each of the data sets having a plurality of data points, each of the data points including a numerical first coordinate and a second coordinate, said machine-implemented method comprising:
a) reading the plurality of data sets;
b) for each of the data sets, multiplying the first coordinate of each of the data points of the data set by a scalar to result in normalized first coordinates for the data points of the data set, the scalar being based upon the first coordinate of one of the data points having a maximum absolute value among the first coordinates of all of the data points of the data set;
c) setting first and second boundaries of a first coordinate axis of the normalized graph based on at least one of a minimum value and a maximum value among the normalized first coordinates of all of the data points of the data sets; and
d) plotting all of the data points of all of the data sets on a same coordinate plane defined by the first and second boundaries of the first coordinate axis and a second coordinate axis using the normalized first coordinates instead of the numerical first coordinates of the data points of the data sets.

2. The machine-implemented method of claim 1, wherein, in step b), for each of the data sets, the scalar is a reciprocal of an absolute value of the first coordinate of said one of the data points having the maximum absolute value among the first coordinates of all of the data points of the data set.

3. The machine-implemented method of claim 2, wherein, in step c), the first boundary is set to be +1, and the second boundary is set to be equal to the minimum value among the normalized first coordinates of all of the data points of all of the data sets.

4. The machine-implemented method of claim 2, wherein, in step c), the first boundary is set to be equal to the maximum value among the normalized first coordinates of all of the data points of all of the data sets, and the second boundary is set to be −1.

5. The machine-implemented method of claim 2, wherein, in step c), the first and second boundaries are set to be +1 and −1, respectively.

6. The machine-implemented method of claim 2, wherein, in step c), the first boundary is set to be equal to the maximum value among the normalized first coordinates of all of the data points of all of the data sets, and the second boundary is set to be equal to the minimum value among the normalized first coordinates of all of the data points of all of the data sets.

7. The machine-implemented method of claim 1, wherein the first and second coordinates of each of the data points are an ordinate and an abscissa, respectively.

8. The machine-implemented method of claim 1, wherein step b) includes, for each of the data sets, determining the absolute values of the first coordinates of all of the data points of the data set, selecting a maximum one of the determined absolute values, and obtaining a reciprocal of the maximum one of the determined absolute values to serve as the scalar of the data set.

9. The machine-implemented method of claim 1, wherein step b) includes, for each of the data sets, arranging the first coordinates of all of the data points of the data set in a sequence according to one of an ascending order and a descending order, selecting first and last ones of the first coordinates in the sequence, determining absolute values of the first and last ones of the first coordinates in the sequence, and obtaining a reciprocal of a larger one of the absolute values of the first and last ones of the first coordinates in the sequence to serve as the scalar of the data set.

10. The machine-implemented method of claim 1, wherein, in step d), the data points of each of the data sets are plotted in a line graph.

11. The machine-implemented method of claim 1, wherein, in step d), the data points of each of the data sets are plotted in a bar chart.

12. The machine-implemented method of claim 1, wherein the second coordinate of each of the data points is an ordinal coordinate.

13. An electronic device capable of presenting a normalized graph for a plurality of data sets, each of the data sets having a plurality of data points, each of the data points including a numerical first coordinate and a second coordinate, said electronic device comprising:
a user interface for allowing user input of an input instruction associated with the data sets;
a reader coupled to said user interface to receive the input instruction, and reading the data sets in accordance with the input instruction;
a normalization module coupled to said reader, and which, for each of the data sets, multiplies the first coordinate of each of the data points of the data set by a scalar to result in normalized first coordinates for the data points of the data set, the scalar being based upon the first coordinate of one of the data points having a maximum absolute value among the first coordinates of all of the data points of the data set;
a boundary-setting module coupled to said normalization module, and setting first and second boundaries of a first coordinate axis of the normalized graph based on at least one of user input, a minimum value among the normalized first coordinates of all of the data points of the data sets, and a maximum value among the normalized first coordinates of all of the data points of the data sets; and
a graph-presenting module coupled to said boundary-setting module, said normalization module, and said reader, and plotting all of the data points of all of the data sets on a same coordinate plane defined by the first and second boundaries of the first coordinate axis and a second coordinate axis using the normalized first coordinates instead of the numerical first coordinates of the data points of the data sets.

14. The electronic device of claim 13, wherein said reader is adapted to be coupled to a database that stores the data sets, and the input instruction received from said user interface causes said reader to read the data sets in said database.

15. The electronic device of claim 13, wherein the data sets are input through said user interface as part of the input instruction, said reader reading the data sets contained in the input instruction received thereby.

16. The electronic device of claim 13, wherein said boundary-setting module is coupled to said user interface, said boundary-setting module setting the first and second boundaries of the first coordinate axis of the normalized graph based on user input of a boundary instruction through said user interface.

17. The electronic device of claim 13, wherein, for each of the data sets, the scalar is a reciprocal of an absolute value of the first coordinate of said one of the data points having the maximum absolute value among the first coordinates of all of the data points of the data set.

18. The electronic device of claim 17, wherein said boundary-setting module sets the first boundary to be +1, and the second boundary to be equal to the minimum value among the normalized first coordinates of all of the data points of all of the data sets.

19. The electronic device of claim 17, wherein said boundary-setting module sets the first boundary to be equal to the maximum value among the normalized first coordinates of all of the data points of all of the data sets, and the second boundary to be −1.

20. The electronic device of claim 17, wherein said boundary-setting module sets the first and second boundaries to be +1 and −1, respectively.

21. The electronic device of claim 17, wherein said boundary-setting module sets the first boundary to be equal to the maximum value among the normalized first coordinates of all of the data points of all of the data sets, and the second boundary to be equal to the minimum value among the normalized first coordinates of all of the data points of all of the data sets.

22. The electronic device of claim 13, wherein, for each of the data sets, said normalization module calculates the scalar of the data set by determining the absolute values of the first coordinates of all of the data points of the data set, selecting a maximum one of the determined absolute values, and obtaining a reciprocal of the maximum one of the determined absolute values to serve as the scalar of the data set.

23. The electronic device of claim 13, wherein, for each of the data sets, said normalization module calculates the scalar of the data set by arranging the first coordinates of all of the data points of the data set in a sequence according to one of an ascending order and a descending order, selecting first and last ones of the first coordinates in the sequence, determining absolute values of the first and last ones of the first coordinates in the sequence, and obtaining a reciprocal of a larger one of the absolute values of the first and last ones of the first coordinates in the sequence to serve as the scalar of the data set.

24. The electronic device of claim 13, wherein said graph-presenting module plots the data points of each of the data sets in a line graph.

25. The electronic device of claim 13, wherein said graph-presenting module plots the data points of each of the data sets in a bar chart.

26. A computer program product comprising a machine-readable data storage medium including program instructions for causing an electronic device to execute consecutive steps of a machine-implemented method fort presenting a normalized graph for a plurality of data sets, each of the data sets having a plurality of data points, each of the data points including a numerical first coordinate and a second coordinate, the machine-implemented method including:
a) reading the plurality of data sets;
b) for each of the data sets, multiplying the first coordinate of each of the data points of the data set by a scalar to result in normalized first coordinates for the data points of the data set, the scalar being based upon the first coordinate of one of the data points having a maximum absolute value among the first coordinates of all of the data points of the data set;
c) setting first and second boundaries of a first coordinate axis of the normalized graph based on at least one of a minimum value and a maximum value among the normalized first coordinates of all of the data points of the data sets; and
d) plotting all of the data points of all of the data sets on a same coordinate plane defined by the first and second boundaries of the first coordinate axis and a second coordinate axis using the normalized first coordinates instead of the numerical first coordinates of the data points of the data sets.
